(19) United States
(12) Patent Application Publication
(10) Pub. No.: US 2020/0384699 A1
(43) Pub. Date: Dec. 10, 2020

(54) METHOD TO INTEGRATE A FIRST PART AND A SECOND PART COMPRISING COMPOSITE MATERIAL

(71) Applicant: Airbus Operations S.L., Getafe (ES)

(72) Inventors: Maria Almudena CANAS RIOS, Getafe (ES); Melania SANCHEZ PEREZ, Getafe (ES)

(21) Appl. No.: 16/892,896

(22) Filed: Jun. 4, 2020

(30) Foreign Application Priority Data
Jun. 6, 2019 (EP) 19382472.9

(51) Int. Cl. B29C 65/34; B29C 65/40; B29C 65/00; B29C 65/72

(52) U.S. Cl. CPC B29C 65/3444; B29C 65/40; B29K 2101/12; B29C 65/72; B29C 66/5326

(57) ABSTRACT

A method to integrate a first part and a second part comprising composite material, both parts being at least partially thermoplastic parts, that comprises the steps of providing the first part, placing the first part in a tool, applying an in-situ consolidation process, such that integration layers of thermoplastic material are laid on thermoplastic plies of the first part and the integration of the first part with the integration layers is obtained, the integration layers being the first layers of the second part, wherein the applied in-situ consolidation process comprises the sub-steps of melting each tape by a heat source, and welding to the layer below, compressing by a roller, and cooling down below melting temperature of thermoplastic, laying the rest of the second part, and curing or consolidation of a remainder of the second part.

### CROSS-REFERENCES TO RELATED APPLICATIONS

This application claims the benefit of the European patent application No. 19382472.9 filed on Jun. 6, 2019, the entire disclosures of which are incorporated herein by way of reference.

### FIELD OF THE INVENTION

This invention refers to a method to integrate a first part and a second part, both of them comprising composite material, and is appropriate to be used in manufacturing structural parts of an aircraft by integrating parts of an aircraft (such as frames, ribs, stringers, beams, etc.) with skins of shells or with other parts of an aircraft.

### BACKGROUND OF THE INVENTION

The manufacturing of integrated parts with thermoset materials in an aircraft is already known in the state of the art. By means of co-curing or co-bonded processes, stringers and/or stiffeners, as shown in FIGS. 1 and 2, could be integrated in a skin, but frames or ribs are normally riveted.

Concerning thermoplastic materials, ribs/frames plus stringers can be integrated with the skin by means of welding instead of riveting/fastening them. There are several heating technologies for thermoplastic welding (induction, resistive, ultrasonic, friction . . . ) but all of them have constraints for aeronautical structural applications in which resins such as PEKK, PEEK, etc., are needed. So far there is no industrialized welding process for structural joints with these materials.

Another manufacturing process to integrate thermoplastic parts with a thermoplastic skin or similar is the in-situ consolidation (ISC) process. In this technology, each tape is melted by a heat source, welded to the layer below, compressed by, e.g., a roller, and cooled down below melting temperature. If this is done properly, an in-situ consolidation can be achieved, which means no additional consolidation process is needed. One drawback of this technology is the low speed at which material should be laid-up to assure the in-situ consolidation. However, nowadays this process is under development trying to reach a higher process speed that makes the technology more suitable for industrial application.

Referring to hybrid thermoplastic-thermoset structures, several patent documents exist that deal with the joining of composite components using low temperature thermoplastic film fusion as PEI or PES. This film is co-consolidating with a semi-crystalline thermoplastic part (prepreg normally) as the ones required in aeronautics (PEEK, PEKK, PPS). Then, this component is joined to a thermoset prepreg fresh laminate (epoxy resin based) in a posterior curing process at 180° C. Air-inlets are made with this process.

### SUMMARY OF THE INVENTION

An object of the present invention is to provide a method to integrate a first part and a second part comprising composite material, both parts being at least partially thermoplastic parts, using the in-situ consolidation (ISC) technology and other technologies and having a higher process speed.

The invention provides a method to integrate a first part and a second part comprising composite material, both parts being at least partially thermoplastic parts, which comprises the following steps:
providing the first part,
placing the first part in a tool,
applying in-situ consolidation process, such that integration layers of thermoplastic material are laid on thermoplastic plies of the first part and the integration of the first part with the integration layers is obtained, the integration layers being the first layers of the second part, wherein the applied in-situ consolidation process comprises the following sub-steps:
each tape is melted by a heat source, and welded to the layer below,
compression by a roller, and
cooling down below melting temperature of thermoplastic,
laying the rest of the second part, and
curing the rest of the second part.

The method of the invention allows to provide a feasible and automated manufacturing process for structural parts (for example, of an aircraft) with the following advantages:

Reduction of Assembly Time.

Reduction of fastening by maximizing integration at a manufacturing level. For example, stringers and frames in aircraft structures can be integrated with more simplified tooling than existing processes.

Reduction of elementary parts to be managed at assembly stages, maximizing the integration at the manufacturing level.

Improvement of the environmental impact by enlarging the use of thermoplastic technology in the aircraft (recyclability).

Automated and Robust Process.

Simplified integration tooling as the thermoplastic part will act as a curing tool for the thermoset laminate.

Integration Assuring the Quality of the Interface.

Manufacturing of all parts/skin not with the same technology but with the optimal one (thermoplastic, thermoset, metal).

Other characteristics and advantages of the present invention will be clear from the following detailed description of the embodiments illustrative of its object in relation to the attached figures.

### BRIEF DESCRIPTION OF THE DRAWINGS

FIG. 1 shows a partial view of a prior art fuselage shell of an aircraft with frames and stringers on the skin of the fuselage shell.

FIG. 2 shows a full thermoset prior art barrel of an aircraft with omega stringers cocured.

FIG. 3 shows the in-situ consolidation (ISC) process schematically.

FIG. 4 shows the parts to be integrated with the method of the invention, as well as the integration layers and the integration element.

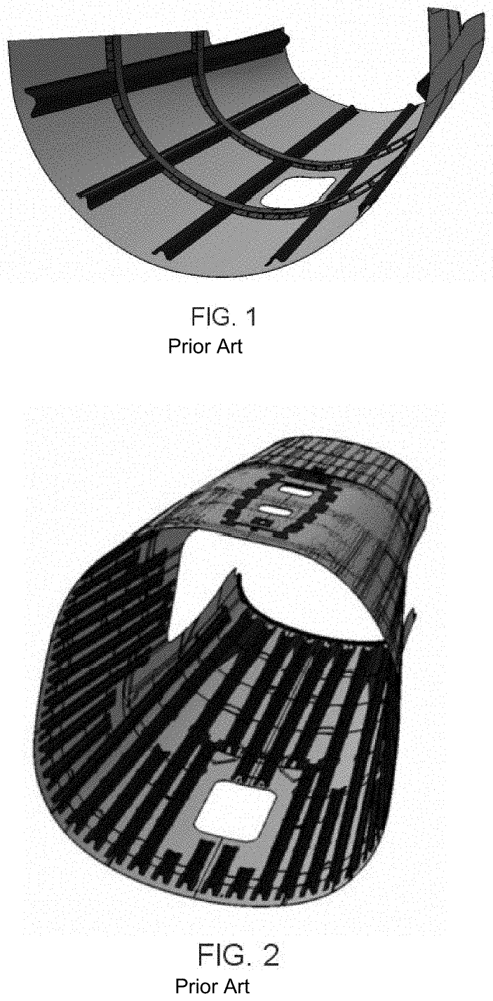

### DETAILED DESCRIPTION OF THE PREFERRED EMBODIMENTS

FIG. 4 shows a first part and a second part, both of them comprising composite material, which can be integrated by means of the method of the invention.

Basically, the method deals with the use of the in-situ consolidation (ISC) technology for the integration of a first part which comprises thermoplastic, to the first layers (hereafter referred to as “integration layers”) of a second part which also comprises thermoplastic, and then it uses another technology for the rest of the thickness of the second part.

The method to integrate a first part and a second part comprising composite material of the invention basically comprises the following steps:
providing the first part,
placing the first part in a tool,
applying in-situ consolidation process, such that integration layers of thermoplastic material are laid on thermoplastic plies of the first part and the integration of the first part with the integration layers is obtained, the integration layers being the first layers of the second part,
laying the rest of the second part, and
curing or consolidation of the rest of the second part.

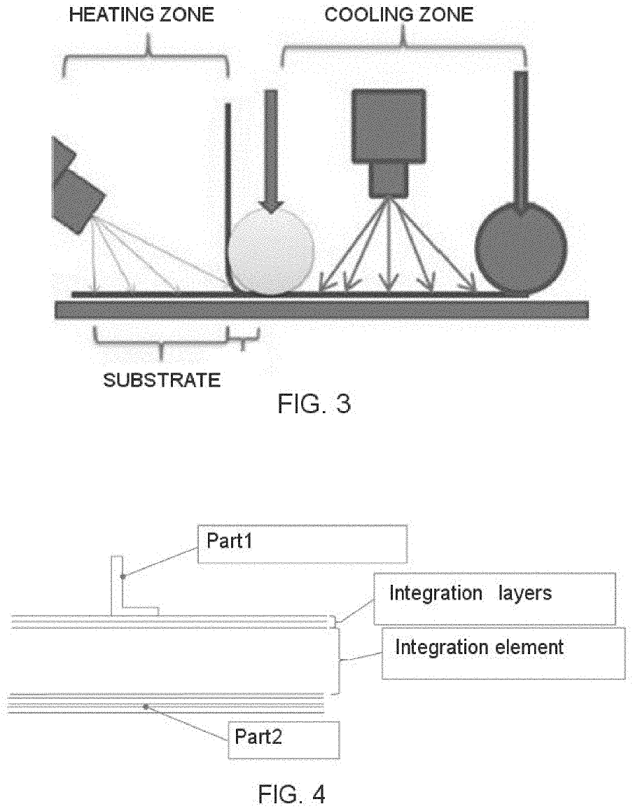

The applied in-situ consolidation process is schematically shown in FIG. 3 and comprises the following sub-steps:
each tape is melted by a heat source, and welded to the layer below, in a heating area
compression by a roller, and
cooling down below melting temperature of thermoplastic, in a cooling area.

As for the material used for the first part, it can be a part completely made of thermoplastic material. It can also be a hybrid part of thermoplastic and thermoset material, or a hybrid part of thermoplastic material and metal. The last plies of the first part (i.e., those in contact with the integration layers of the second part) are made from thermoplastic.

As for the material used for the second part, it can be completely made of thermoplastic material. It can also be a hybrid part with integration layers of thermoplastic material and thermoset material in the rest of the second part. The second part can additionally comprise metal.

When the second part is a hybrid part with integration layers of thermoplastic material and thermoset material in the rest, the integration layers and the rest of the second part are joined, if needed, by means of integration elements that will be placed/applied between integration layers and thermoset plies before the curing step of the rest of the second part.

The method is specifically applicable to integrate thermoplastic parts into thermoplastic/thermoset material skins or other parts of an aircraft.

The integration elements can be, for example:

Structural adhesive bonding to join dissimilar materials (e.g., thermoplastics to thermosets or metals).

Multiple bonded system combinations.

Surface preparation to prevent or remove contaminants and also to create chemically active sites improving the bonding.

Material with processing temperature between the ones of the integration layers and the second part.

As for the first part, when the method is used in manufacturing structural parts of an aircraft, it can be a frame, a rib, a stringer or a beam, for example. The second part is usually the skin of a shell of an aircraft, but it can also be other parts, such as a frame, a rib, a stringer or a beam, for example.

The integration layers can be laid out in planes, but they can also be in complex shapes.

Focused in automation and to assure quality of the interface, integration thermoplastic layers can be laid through an automatic placement machine (APM) and consolidated at the same time (ISC process). With this process, the first ply (that will be in contact with the first part to be joined) will assure the quality of the interface and will allow the integration of several and complex parts in one-shot. The second part can also be laid by means of an automated laying machine (ISC for thermoplastic and AFP—Automated Fiber Placement for thermoset) but any other process is also applicable (depending on the type of material thermoset, thermoplastic or metal). Integration elements act as curing/consolidation tool for the second part if a second step process is needed.

Integration layers are supposed to be essentially first plies of the second part, but they could be also part of a hybrid first part.

Although the present invention has been fully described in connection with preferred embodiments, it is evident that modifications may be introduced within the scope thereof, not considering this as limited by these embodiments, but by the contents of the following claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method to integrate a first part and a second part comprising composite material, both parts being at least partially thermoplastic parts, comprising the following steps:
providing the first part,
placing the first part in a tool,
applying an in-situ consolidation process, such that integration layers comprising tapes of thermoplastic material are laid on thermoplastic plies of the first part and integration of the first part with the integration layers is obtained, the integration layers being first layers of the second part, wherein the applied in-situ consolidation process comprises the following sub-steps:
melting each tape by a heat source, and welding to a layer below,
compressing the tapes and layers by a roller, and
cooling down the tapes and layers below a melting temperature of thermoplastic,
laying a remainder of the second part, and
curing or consolidating the remainder of the second part.

2. The method to integrate the first part and the second part comprising composite material, according to claim 1, wherein the second part is made of thermoplastic material.

3. The method to integrate the first part and the second part comprising composite material, according to claim 1, wherein the second part is a hybrid part with integration layers of thermoplastic material and a remainder of the second part is made of thermoset material, and the integration layers and the remainder of the second part are joined via integration elements before the curing step of the remainder of the second part.

4. The method to integrate the first part and the second part comprising composite material, according to claim 1, wherein the second part additionally comprises metal.

5. The method to integrate the first part and the second part comprising composite material, according to claim 3, wherein the integration elements comprise at least one of:
structural adhesive bonding,
surface preparation, or
material with a processing temperature between processing temperatures of the integration layers and the remainder of the second part.

6. The method to integrate the first part and the second part comprising composite material, according to claim 1, wherein the first part is a hybrid part of thermoplastic and thermoset material.

7. The method to integrate the first part and the second part comprising composite material, according to claim 1, wherein the first part is a hybrid part of thermoplastic material and metal.

8. The method to integrate the first part and the second part comprising composite material, according to claim 1, wherein the first part is a frame or a rib or a stringer or a beam or a stiffener.

9. The method to integrate the first part and the second part comprising composite material, according to claim 1, wherein the second part is a skin, a frame, a rib, a stringer, or a beam.

10. The method to integrate the first part and the second part comprising composite material, according to claim 1, wherein the integration layers are laid out on planes.

11. The method to integrate the first part and the second part comprising composite material, according to claim 1, wherein the integration layers of thermoplastic material are laid through an automatic placement machine and consolidated at the same time with the in-situ consolidation process.

12. The method to integrate the first part and the second part comprising composite material, according to claim 3, wherein the remainder of the second part of thermoset material is laid by automated fiber placement using an automated laying machine.

13. The method to integrate the first part and the second part comprising composite material, according to claim 3, wherein the integration elements comprise structural adhesive bonding.

14. The method to integrate the first part and the second part comprising composite material, according to claim 3, wherein the integration elements comprise surface preparation.

15. The method to integrate the first part and the second part comprising composite material, according to claim 3, wherein the integration elements comprise material with a processing temperature between processing temperatures of the integration layers and the remainder of the second part.
